(19) United States
(12) Patent Application Publication
(10) Pub. No.: US 2009/0081613 A1
(43) Pub. Date: Mar. 26, 2009

(54) IMPLANT ANALOG

(75) Inventors: Stefan Ihde, Uetliburg (CH); Bernhard Menzel, Stuttgart (DE)

Correspondence Address: HUSCH BLACKWELL SANDERS LLP, 190 CARONDELET PLAZA, SUITE 600, ST. LOUIS, MO, 63105-3441, US

(73) Assignee: BIOMED EST., Vaduz (LI)

(21) Appl. No.: 12/238,783

(22) Filed: Sep. 26, 2008

Related U.S. Application Data
(63) Continuation-in-part of application No. 11/385,526, filed on Mar. 21, 2006, now abandoned.

(30) Foreign Application Priority Data
Mar. 24, 2005 (DE) DE102005014582.5
Jun. 7, 2005 (DE) DE102005027184.7

(51) Int. Cl. A61C 8/00

(52) U.S. Cl. 433/173

(57) ABSTRACT

Implant analog for custom production of prosthetic superstructures for inserted dental implants, inserted into a master cast directly or indirectly via a model sleeve comprising an implant head equipped with elements to hold and fasten an implant system; a base of said implant analog having a cross section that tapers over at least part of its length; an implant head having a working surface and a connecting piece; a tenon-like projection on a bottom end surface of said implant head; and an external thread dimensioned to connect with a screw element. The analog may be removable through the bottom of the base.

### CROSS-REFERENCE TO RELATED APPLICATIONS

This application is a continuation-in-part of U.S. patent application Ser. No. 11/385,526 filed on Mar. 21, 2006. This application claims priority to German applications DE 10 2005 027 184.7 filed on Jun. 7, 2005 and DE 10 2005 014 582.5 filed Mar. 24, 2005.

### BACKGROUND OF THE INVENTION

1. Field of the Invention

The invention concerns an implant analog for the production of custom-made prosthetic structures on dental implants using a master cast.

2. Related Art

In the field of dental implantology, before surgical placement of implants in a patient's mouth, an assembly of a prosthetic device and implants is custom fit to the patient's mouth. Custom fitting involves taking an impression of the patient's mouth in a known fashion and reproducing a facsimile of the patient's mandible and/or maxilla in the form of a model. Models may be comprised of gypsum or other materials. The models are mounted on a base. The custom fitting of the prosthetic device proceeds with the use of an implant analog that is placed in the model in a position analogous to the desired ultimate position into which the implant itself will be surgically implanted in the patient's mandible or maxilla. The prosthetic device can be a crown, bridge or a more complete set of prosthetic teeth.

The custom fitting procedure must be able to accommodate the great variability of the shape of the mandible or maxilla from patient to patient. Some fittings will require the implant analogs to be placed in the model at an angle that is not vertical to the base. Where multiple implants will be used to support a prosthetic device, the angles at which each implant is placed in the model can vary. During the fitting procedure it is possible for one implant analog to properly engage the prosthetic device while a separate implant analog fails to engage properly or may even break. In the event adjustments are needed, delay, inaccuracy and other problems may arise where the prosthetic device and implant analogs must be removed from the top of the model, that is, from the side of the model engaging the prosthetic device. If only a single implant analog needs to be adjusted, it is problematic to remove the entire bridge and other implants. Where the angle of implant analogs vary, it is also problematic to remove them. If an individual analog is damaged it may be difficult to remove it without the time and consequent expense of removing the entire assembly.

Implant analogs represent the implant present in the mouth of the patient. If abutments are already mounted on the implant, the implant analogs can also represent the abutments. Likewise, implant analogs can also represent parts of the abutment and of the implant in some implant systems.

Implant analogs used to make master casts for subsequent production of custom-made prosthodontic superstructure in exact agreement with the implants in the jawbones are themselves known. The implant analog is included in the master cast, with the future prosthodontic superstructure being attached to the head of the implant analog and, after the implant superstructure has been produced, transferred to the implant inserted in the mouth of the patient. The anatomic structure of the jaw (morphology) of the patient often does not allow the dental implant to be inserted perpendicularly. In the fabrication of the master cast, this presents substantial difficulties in placing the implant analogs in a manner that ensures simple production and manipulation of the waxup and of the cast structure on the master cast in the event that implants are present that are not inserted perpendicularly. The objective of the invention is to develop the generic implant analog such that the working casts for the implant-based dental work can be produced reliably and easily.

This objective is attained according to the invention with implant analog for custom production of prosthetic superstructures for inserted dental implants, inserted into a master cast directly or indirectly via a model sleeve comprising an implant head equipped with elements to hold and fasten an implant system; a base of said implant analog, having a cross section that tapers over at least part of its length; an implant head having a working surface and a connecting piece; a tenon-like projection on a bottom end surface of said implant head; and an external thread dimensioned to connect with a screw element.

In the implant analog according to the invention, the base of the implant analog which has a head for mounting the dental implant is designed so that its cross-section is tapered over at least part of its length. Due to this form of the base, it is possible to remove the implant analog from the master cast without stress.

After fitting, individual implant analogs may be advantageously reused, if they are readily removable from the model, which is not always the case.

Other features of the invention appear from the other claims, the description, and the drawings.

### SUMMARY OF THE INVENTION

The invention concerns an improved implant analog for production of custom-made prosthetic structures for inserted dental implants.

The anatomic structure of the jaw often does not allow dental implants to be inserted perpendicularly. That results in unavoidable problems in producing prosthetic implants, combined with high expenditures and costs.

The invention eliminates those disadvantages for an implant analog (2). The implant head (5) has a working surface (11) and connecting piece (12) on which the implant reconstructions to be made can be seated and fastened and the bottom end surface (45) of implant analog (2) has a tenon-like projection (36) with an external thread intended for connecting a screw element (39, 54, 58).

The implant analog can be used equally well for single-tooth implants and for implanted bridges.

The invention comprises an implant analog and sleeve, and may comprise an implant analog system comprising an implant analog, sleeve, model and base, wherein the analog may be removed from the model assembly from the bottom or base side of the model.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained by means of some embodiments shown in the drawings. Those show:

FIG. 1 depicts a partial section of a master cast in a partially perspective representation with implant analogs inserted according to the invention.

FIG. 2 depicts an enlarged perspective representation of the implant analog according to the invention.

FIG. 3 depicts another embodiment of the implant analog of FIG. 2.

FIG. 4 depicts a third embodiment of the implant analog corresponding to FIG. 2 in which the working surface is set obliquely to the longitudinal axis of the basic body of the implant analog.

FIG. 5 depicts a perspective representation of an equalizing sleeve for the implant analog.

FIG. 6 depicts the perspective representation of an outer sleeve for the equalizing sleeve of the implant analog.

FIG. 7 depicts the underside of the outer sleeve in a perspective representation.

FIG. 8 depicts another embodiment of an implant analog according to the invention, which can be screwed into the master cast with a backing piece.

FIG. 9 depicts a plan view of the implant analog according to FIG. 8 in the direction of arrow IX with an oval structure for the mounting cone, which is cast into the master cast.

FIG. 10 depicts variant embodiments of the implant analog shown in FIGS. 8 and 9.

FIG. 11 depicts variant embodiments of the implant analog shown in FIGS. 8 and 9.

FIG. 12 depicts the arrangement of implant analogs according to the invention, which are inserted into the outer sleeve and screwed to it.

FIG. 13 depicts the arrangement of implant analogs according to the invention, which are inserted into the outer sleeve and screwed to it.

FIG. 14 depicts another embodiment, with which the implant analog is screwed, at its underside, to a conical backing piece.

FIG. 15 is a cutaway side view of the implant analog and sleeve.

FIG. 16 is a top view of the implant analog and sleeve.

FIG. 17a is a side view of the implant analog and sleeve and prosthetic device.

FIG. 17b is a side view of the implant analog and sleeve and prosthetic device.

FIG. 18 is a cutaway end view of the implant analog model and base system.

### LIST OF REFERENCE NUMBERS

1 Master cast

2 Implant Analog

3 Base

4 Anti-rotation element

5 Head

6 Sleeve

7 Retention element

8 Bevel

9 End

10 Jacket

11 End

12 Connecting piece

13 Compensating shell/inner sleeve

14 Base

15 Edge

16 Slot

17 Inner wall

18 Retention element

19 Outer sleeve

20 End

21 Bar

22 Bar

23 Jacket surface

24 Jacket surface

25 Inner wall

26 Bar

27 Opening

28 Bar

29 Circular section

29′ Opening

30 Pin

31 Profile

32 Rib

33 Rib

34 Diagonal

35 End surface

36 Stop

37 Outside thread

38 Outer sleeve

39 Screw

40 Seat

41 Cylindrical outside

42 Seat part

43 Sleeve part

44 End surface

45 Shoulder surface

46 Inner wall

47 Screw slot

48 Shoulder

49 Outer sleeve

50 Seat part

50′ Inner wall

51 Jacket surface Sleeve part

52 Retention element

52′ Retention element

53 Shoulder surface

54 Screw

55 Taper

56 Taper

57 Jacket surface

58 Backing piece

59 Annular wall

60 Opening

61 Thread hole

62 End surface

### DETAILED DESCRIPTION OF THE PREFERRED EMBODIMENTS

The following description of the preferred embodiment(s) is merely exemplary in nature and is in no way intended to limit the invention, its application, or uses.

The implant analogs described in the following are selected according to the space available in the impression and are placed in the impression, connected reversibly to the impression post. Subsequently, a casting is made of the impression, giving the master cast. The implant analogs are equally suitable for single-tooth implants and for bridge implants, as well as for telescope crown and bridge work or zirconia-based restorations in the dental laboratory. With the appropriate working surface, they can be used for any implant system.

In implant technology, shaped pieces, preferably made of titanium, are initially used as root replacements. They are generally made up of an implant that is inserted into a previously drilled hole in the jawbone. As a general rule, a spacer or abutment of titanium is fastened to that shaped piece or implant. Subsequently, the artificial tooth or superstructure is anchored to that spacer or abutment. An accurate model of the patient's jaw is made so that the artificial tooth or bridge can be fitted exactly to the jaw. First, a negative impression of the jaw is produced with an impression tray filled with impression compound, using system-specific impression posts as carriers. It is removed from the jaw and filled with a casting material that, after hardening, represents an accurate model of the patient's jaw. In place of the implant, an implant analog is inserted into the so-called master cast. The implant analog is placed in the model with its working surface oriented and positioned by exact analogy with the implant in the patient's jaw. Divergences between the implants can now be compensated in a very advantageous manner by the implant analog according to the invention.

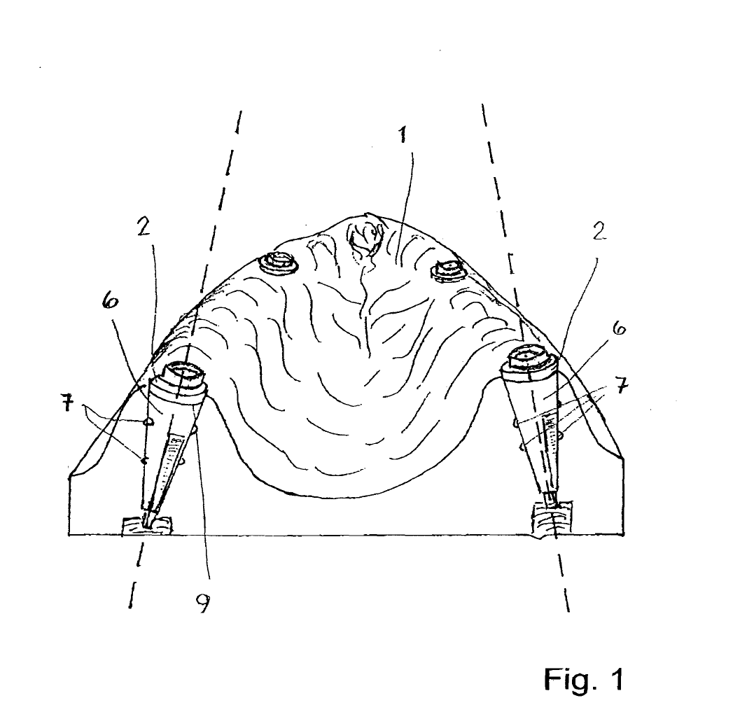

FIG. 1 shows such a master cast (1) with four implant analogs (2) inserted. They, or their bases, are embedded in the master cast (1) in exactly the same positions and orientations as the implant working surfaces in the mouth of the patient. The implant analogs (2) are tapered in the direction of insertion, and can otherwise have any desired cross section, as will be explained later.

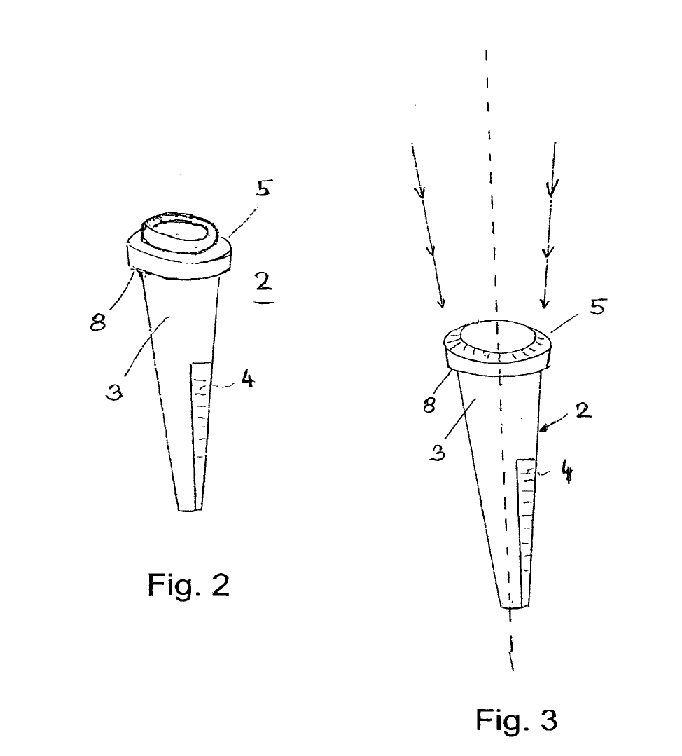

As FIG. 2 shows, the implant analog (2) has a circular cross section and a conical base (3), which has at least one flat (4) on its outside which acts as an anti-rotation means to prevent rotation of the implant analog (2). The base (3) can also have at least one longitudinal slot as the anti-rotation means, for example. In the example embodiment shown, the anti-rotation element (4) extends from the open end of the base (3) over about half of its length. Obviously, the anti-rotation element (4) can also be shorter or longer, or applied only to the base of the implant analog (2), that is, directly opposite the working surface (5).

A head (5), which can be designed in the known manner, corresponding to the particular implant system, sits at the wider end of the base (3). The head (5) forms the working surface, which corresponds to the surface of the implant in the jawbone. The dental technology product is set onto the implant analog in the direction of the arrows.

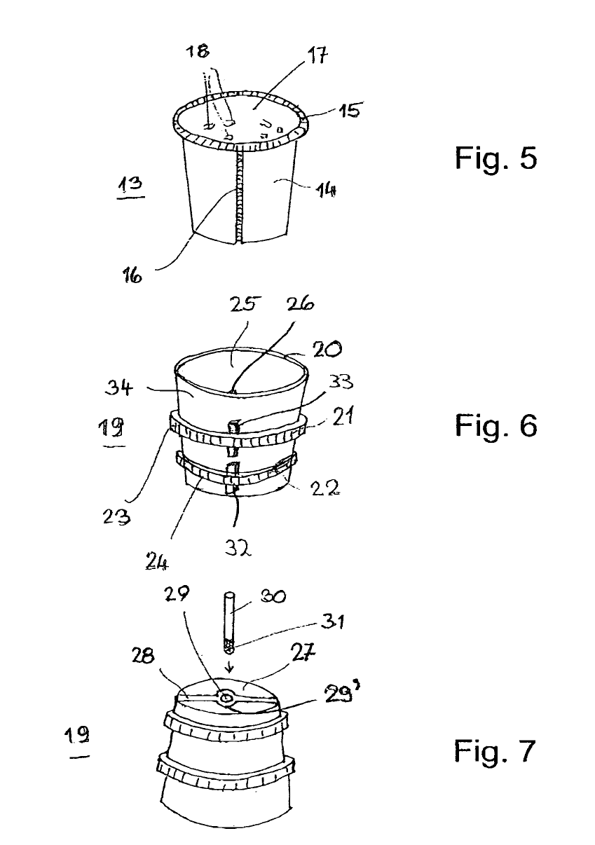

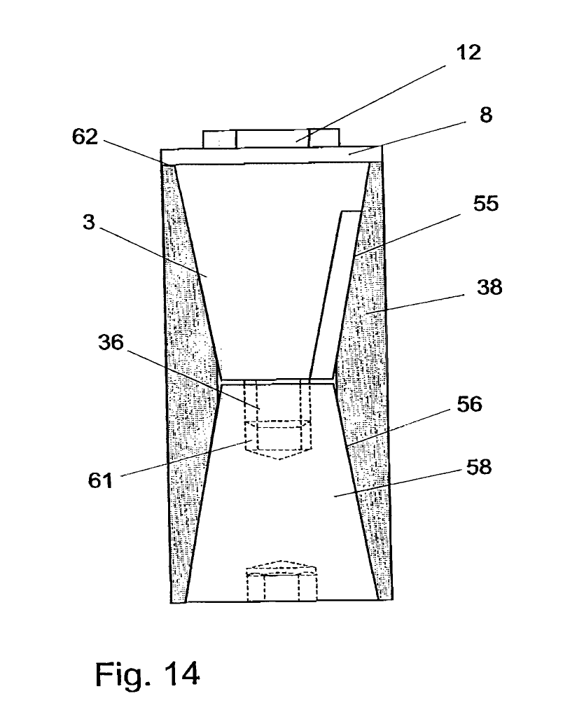

The conicity of the base (3) varies depending on the size, length, and shape of the implant analog (2). In the example embodiment, the cone angle is only a few degrees, and is in the range of about 15°. Because of their conicity, the implant analogs can also be used for implants that have not been inserted perpendicularly into the jawbone. In that case, the angulation of the implant analog is equal to the relative angulation of the implants and allows the bridge to be removed from the master cast in one piece and optionally together with the implant analogs. It is advantageous to use the implant analogs (2) so that they can be removed from the master cast (1) and reinserted into it. In particular, it is possible, in this way, to produce a model for implant-supported bridges using wax so that the modeled wax bridge, together with the conical implant analog (2), can be removed from the master cast (1) without strain and without stress. Furthermore, every individual implant analog (2) can be removed from the master cast without problem. That prevents distortion of the modulation on removal of the framework, so that no tedious soldering or laser-welding necessitated by distortion or new production are required, as is the case with the usual designs. To be able to arrange the implant analog in the master cast (1) better, a sleeve (6) can optionally be used (FIG. 1). It is also designed to be conical (FIGS. 5-6) or biconical (FIG. 14), and has an internal shape that matches the external shape of the implant analog (2) to be embedded in the model. The sleeves (6, 14, 34, 38) are preferably provided on their outsides with retention elements (7, 16, 21, 22, 52, 52′) with which they can be anchored securely in the master cast (1). These retention elements (7, 16, 21, 22, 52, 52′) can each have suitable shapes. The sleeves are cast into the model in production of the master cast (1), with the retention elements acting simultaneously to prevent any twisting.

So that it is possible to check that the base (3) of the implant analog (2) is sitting securely in the sleeve (6, 14, 34, 50, 38), the sleeve or the implant analog (2) has, in the region visible after casting of the model, a defined transition region to the implant analog (2), preferably a step or a bevel (8) which extends radially past the wider end of the base (3). The implant analog (2) is inserted into the sleeve (6) so far that the implant analog (2) fits, preferably precisely, with this bevel (8) on the end (9) of the sleeve. The sleeve (6, 14, 34, 50, 38) can be produced of metal or similarly stable material. As the region in which the bevel (8) of the implant analog (2) fits closely to the end (9) of the sleeve (6, 14, 34, 50, 58) can be exposed by a removable papilla, a visual check of the satisfactory seating of the implant analog (2) in the sleeve (6, 14, 34, 50, 38) at any time is assured. The head has a centrally projecting connecting piece (12).

FIG. 3 shows an implant analog (2) that is designed the same as the implant analog of FIG. 2 except for the head (5). It also has a conical base (3) provided with at least one anti-rotation element (4). In the present example embodiment, the anti-rotation element (4) is executed as a flattening. At the transition from the head (5) to the base (9) there is the bevel (8), which the implant analog (2) fits against in the manner previously described at the end (9) of the sleeve (6, 13, 34, 50, 38) if the implant analog (2) is placed in the master cast (1) so that it can be removed. The head (5) differs from the previous embodiment in that it has no connecting piece.

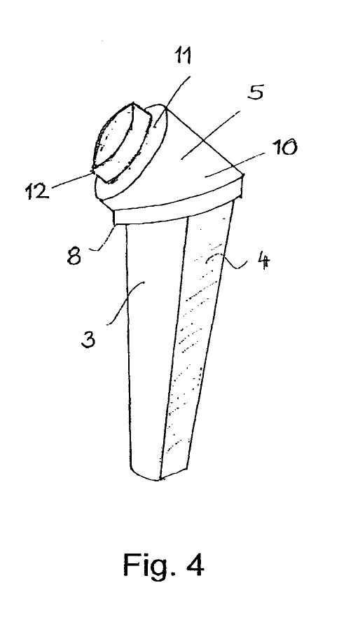

FIG. 4 shows an embodiment in which the head (5) is placed at an angle to the base (3). The base (3) is again conical and has at least one anti-rotation element (4) that is provided, for instance, as a flattening on the outside of the base (3). Differing from the previous example embodiments, this anti-rotation means extends along the entire length of the base (3). The bevel or a collar (8) is placed at the transition from the base (3) to the head (5). The axis of the head (5) runs at an obtuse angle to the axis of the base (3). The head (5) has a cylindrical jacket (10) and a flat front end 11, from which the connecting piece (12) projects centrally. This implant analog (2) is used particularly for implants that are not inserted perpendicularly into the jaw because the angulation provides that all the implant analogs can be arranged to run parallel with each other in spite of divergences of the implants used in a model. Thus, the prosthetic workpiece can later be removed from the master cast (1) in one piece with the implant analogs.

A compensating sleeve, described by FIGS. 5 to 7, is used for implants inserted extremely non-perpendicularly. Even standard model implants can be used when these sleeves are used. The compensating sleeve is used if the angle is large, more than about 25°, for instance. The angled implant analogs are selected appropriately by the dental technician.

The compensating sleeve (13) according to FIG. 5 is an inner sleeve that holds the implant analog (2) and is fastened that of the implant analog. If the inner sleeve (13) is to be placed in the master cast (1) so that it is removable, then the outer sleeve (19) shown in FIGS. 6 and 7 is also used, which is anchored in the master cast (1) and in which the inner sleeve (13) is inserted according to FIG. 5. The inner sleeve (13) and the outer sleeve (19) are designed slightly conical, and can consist of metal or plastic.

The compensating sleeve (13) according to FIG. 5 has a conical base (14) which has on its outer side a peripheral edge (15) directed radially outward. The sleeve (13) is designed open at its narrower end. There is a slot (16) extending over the length of the base (14) in the outer side of the base (14). It is parallel to the axis, and can be formed by shaping the jacket of the base (14) or by depressing into the jacket of the base.

The conic inner wall (17) of the base (14) is provided with retention elements (18), which project into the sleeve (13) and can have any suitable form. These retention elements assure interlocking with the plastic, resin, or impression compound put into the sleeve later.

The radially projecting edge (15) acts as a stop if the sleeve (13) is inserted into sleeve (19) according to FIGS. 6 and 7. That is the case if the sleeve (13) is arranged in the master cast (1) so that it can be removed along with the implant analog (2) and can be replaced in the master cast again if necessary. In this case, the sleeve (13), as the inner housing, is inserted into the outer housing (19) so far that the edge (15) fits tightly against the end (20) of the outer housing (19). The outer sleeve (19) is firmly anchored axially in the master cast (1). For that purpose, it has, for instance, two peripheral bars (21, 22) in radial planes on its outer conical side 34, which are separated axially from each other and form an anchor by means of which the outer sleeve (19) can be firmly anchored in the master cast (1). The bars (21, 22) can have profiles and the like on their outer surfaces (23, 24) to improve the anchoring in the master cast (1). To achieve anti-rotation protection for the outer sleeve (19), it is provided with at least one rib (32, 33) running perpendicular to the bars (21, 22) and protruding beyond the outside of the outer sleeve (19). The example embodiment has two ribs (32, 33) which are perpendicular to the peripheral bars (21, 22), which cross the ribs (32, 33) at their midpoints. The two ribs (32, 33) are at the same height and are separated from each other. Other ribs may be distributed over the periphery of the outer sleeve (19). The ribs (32, 33) can also be moved apart from each other in the peripheral direction and, deviating from the design shown, can have any other suitable shape that assures protection of the outer sleeve (19) against rotation.

A bar 26 projecting inward and running in the axial direction is provided on the conical inner wall (25) of the outer sleeve (19). Its shape is matched to that of the slot (16) of the sleeve (13). If the sleeve (13) is inserted into the outer sleeve (19), then the bar 26 engages with the slot (16), so that the two sleeves (13, 19) fit together so that they cannot rotate.

The outer sleeve (19) is designed open at its narrower end (FIG. 7). A bar (28) running radially, which is fastened to the inner side of the sleeve (19) is provided in the opening (27). There is a circular section 29 with a central opening (29′) at the midpoint of the bar (28), or concentric with the opening (27), into which a pin (30) can be inserted. It has a circular cross-section and has retention elements or profiles (31) at its end to assure that the pin (30) is firmly anchored in the casting material.

In production of the master cast (1) the outer sleeve (19) is first placed on the inner sleeve (13) and the pin (30) is inserted into the opening (29′) of the bar (28) of the outer sleeve (19). Then that unit is clamped in a dental surveyor with which the compensating sleeve (13) and the outer sleeve (19) are fixed in the selected direction on the implant analog already inserted into the impression. The height of the pin (30) is adjusted accurately by sliding it. Then the inner or compensating sleeve (13) is filled with a liquid plastic or resin. In this process, the end of the pin (30) with the profiling 31 is included in the casting. After the model is produced, a silicone molding which serves to make a removable papilla is made over the jaw region of the implant. Thus, the edge (15) of the compensating sleeve (13) is exposed on the plaster model, so that the seating of the compensating sleeve (13) in the outer sleeve (19) can be checked properly.

Because of the use of the outer sleeve (19), the compensating or inner sleeve (13) with the implant analog can be removed from the master cast (1) and replaced exactly. If this removability is not needed, the compensating sleeve (19) can also be cast and anchored directly in the master cast (1).

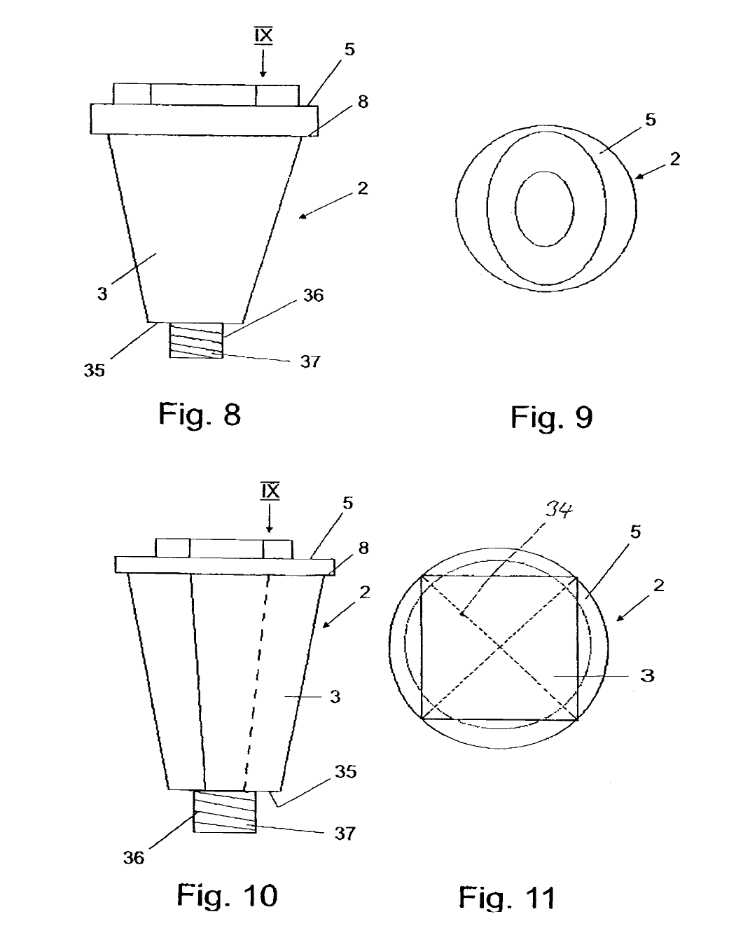

FIGS. 8 to 13 show other embodiments of implant analogs (2), each of which have different cross-sectional shapes.

The implant analog (2) according to FIGS. 8 and 9 differs from the one shown in FIG. 2 in that its base (3), tapering in the direction of insertion into the master cast (1) according to FIG. 1, has an oval or elliptical cross section. The head (5) and the collar (8) are made circular and have a diameter that is greater than the maximum width of the base (3). Because the cross sectional shape of the base (3) is not circular, no additional protection against rotation is needed.

The oval shape of the base (3) or of the holding cone further makes it possible for this implant analog (2) to be cast directly into the master cast without further protection against rotation.

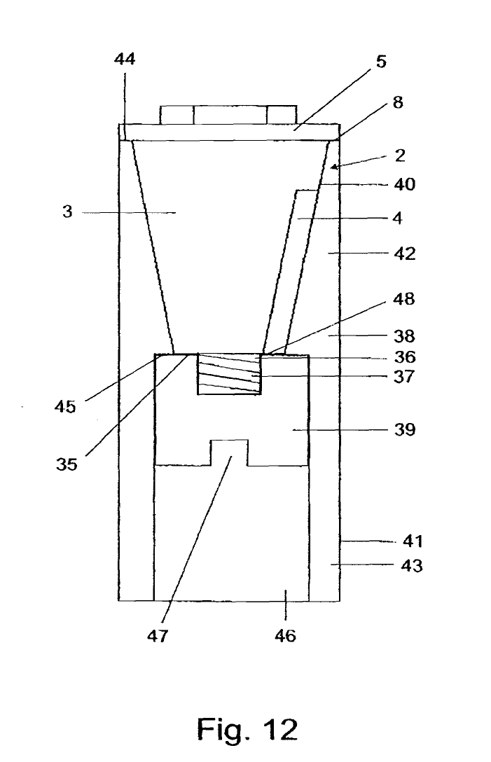

In the example embodiment, the small exposed end (35) of the base (3) is larger than in the embodiment shown in FIG. 2. A tenon-like projection (36) with an external thread (37) is provided on the exposed end surface (35). By means of this external thread (37), the implant analog (37) can be mounted in an outer sleeve (38) by means of a screw (39) and screwed to it—FIG. 12. Instead of the projection (36), a hole with an internal thread can be provided, into which a screw or the like can be screwed to fasten the implant analog (2) in an outer sleeve (38).

The implant analog (2) according to FIGS. 10 and 11 differs from the implant analog described previously in that its base (3), designed as a taper, has an angular cross section, square in the example embodiment. The head (5) of the implant analog (2) has a circular periphery. As FIG. 11 shows, the bevel (8) has a circular periphery such that its diameter is the same as the length of the diagonal (34) of the largest cross-sectional surface of the base (3)—FIG. 11. The smaller end surface (35) of the base (3) again carries a tenon-like projection (36) with an external thread (37). A hole with an internal thread, not shown, can also be provided instead of the projection (36).

The implant analog (2) according to FIG. 12 is essentially equivalent to the embodiment in FIGS. 10 and 11. The base (3) is made circular, while the connecting piece (12) has a hexagonal shape. Again, a flat (4) acts to prevent rotation. It extends over part of the length of the base (3) and preferably has the same width over its longitudinal extent. A tenon-like projection (36) with an external thread (37) connects to the smaller end (35) of the base (3). Again, a hole with an internal thread can be provided instead of this projection (36).

The implant analog (2) is inserted into an outer sleeve (38) and is fastened in that outer sleeve (38) by a screw (39) that is screwed onto the projection (38). The outer sleeve (38) has a seat part (42) for the base (3) of the implant analog (2) and has a conical seat (40), with the base (3) of the implant analog fitting tightly to its internal wall. The internal wall of the seat (40) is provided with a corresponding flat in the region of the anti-rotation element (4).

A sleeve part (43) having a cylindrical inner wall (46) connects to the seat part (42) and accepts the screw (39). The transition between the seat (40) and the cylindrical inner wall (46) forms an internal shoulder surface (45) that supports the screw (39) when the implant analog (2) is mounted. The implant analog (2) is screwed into the seat (40) until its collar (8), which is made circular, fits tightly against the end surface (44) of the seat part (42). The diameter of the bevel (8) is the same as the outside diameter of the seat part (42).

The sleeve part (43), which has the same outside diameter as the seat part (42), keeps the casting material away from the screw (39) during production of the master cast (1). The screw (39) can be turned easily with a screwdriver through the open end of the sleeve part (43). The screw (39) has a screw slot (47) for that purpose. The implant analog (2) can be clamped in the outer sleeve (38) with the screw (39), so that it cannot be separated accidentally. Retentions, such as bars, ribs or the like can be provided on the cylindrical outside (41) of the outer sleeve (38) as anti-rotation means and/or as anchoring means (not shown). It is possible to make at least the sleeve part (43) oval, elliptical, or angular in its cross section so that no special anti-rotation means is required.

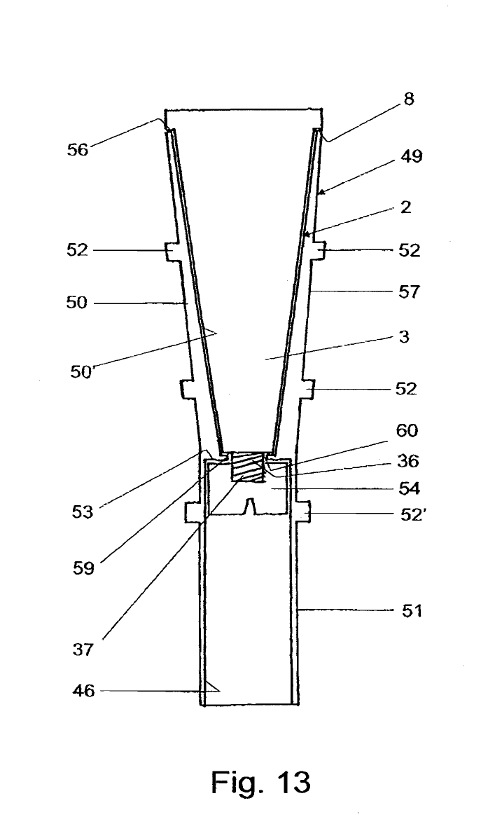

As shown in FIG. 13, the implant analog is seated in an outer sleeve (49). The implant analog (2) can be designed according to one of the example embodiments 2 to 12. The outer sleeve (49) has a seat part (50) and a sleeve part (51). The seat part (50) has a seat (50′), and the inner wall of the base (3) of the implant analog (2) lies tightly against it. The outer jacket surface (57) of the seat part (50) is a conical jacket, the diameter of which tapers toward the sleeve part (51). Its external jacket surface is cylindrical.

The outer sleeve (49) is designed in one piece, corresponding to the embodiment of FIG. 12. It can consist of a metallic material or a plastic, especially a thermosetting plastic. The outer sleeve (49) is given a retention element (52, 52′), which can be formed by projecting knobs, tenons, bars, and the like in the vicinity of the seat part (50) and the sleeve part (51).

There is a shoulder surface (53) directed radially inward at the transition from the cylindrical inner wall (46) of the sleeve part (51) to the conical inner wall (50′) of the seat part (50). Differing from the previous embodiment, it projects radially inward over the inner wall (50′). This produces a thin annular wall (59). The annular wall (59) bounds an opening (60) through which the tenon-like projection (36) of the base (3) projects, with the outer thread in the inner space of the cylindrical sleeve part (51).

A screw (54) with internal thread is inserted into the inner space of the sleeve part (51) and screwed onto the projection (36) to hold the implant analog (2) to the outer sleeve (49). In this way the base (3) of the implant analog (2) is drawn into the inner cone of the seat part (50) until the bevel (8) or the collar lies tightly against the end surface (56) of the seat part (50).

Instead of the projection (36) with the external thread (37), a hole with an internal thread can be provided in the base (3) of the implant analog (2), into which an ordinary screw can be screwed to fasten the implant analog (2) in the cylindrical part of the outer sleeve (49).

FIG. 14 shows another preferred fastening of the implant analog (2) in an outer sleeve (38). The outer sleeve (38) has an upper cone (55) that serves as a seat for the implant analog (2), and a lower cone (56) that runs in the opposite direction from cone (55) and holds a conical backing piece (58). The backing piece (58), which has a threaded hole (61), is inserted from the underside of the master cast (1) into the outer sleeve and screwed to the implant analog (2) with the external thread (37) of the tenon-like projection (36) to hold it to the outer sleeve (38). When the backing piece (58) is screwed in, the base (3) of the implant analog (2) is drawn into the upper cone (55) until the collar or bevel (8) lies against the end surface (62) of the outer sleeve (38). To the extent that exact repositioning in the master cast (1) is assured, the implant analog (2) and the backing piece (58) can also be clamped together directly in the master cast (1)even without an outer sleeve (38), and the implant analog (2) can be positioned reliably in this relatively simple manner.

In the example shown, the working surface or head (5) of the implant analog (2) has a hexagonal connecting piece (12). Other polygonal shapes such as triangular, quadrangular, or octagonal connecting pieces can also be provided instead of this hexagonal connecting piece (12). Alternatively, connecting pieces can also be provided in the form of an internal cone, internal cones combined with an internal polygon, a bayonet connection, Torx designs or combinations of those in the working surface or in the head of the implant analog (2). The choice is guided solely by the particular implant desired.

Instead of the screw connections described, it is also possible to fasten the implant analog (2) into the outer sleeve with other fastening means, for example, with a notch or clip connection, with a bayonet connection, with a bolt, a split pin, and the like.

The base (3) of the implant analog (2) can also be designed in a star or kidney shape or have some other configuration, instead of the conical, oval, elliptical or angular cross-sectional shapes. In any case, the base (3) must be tapered in the direction of insertion.

The implant analogs described (2 or 13) can also be used with extremely oblique position of the inserted implants as well as to produce implant reconstructions for single-tooth implants and for implant-supported bridges. Quite different implant analogs (2) can be inserted into the seating sleeves (6, 19, 38, 49), each of them lying with its base (3) tightly against the inner wall of the seats of the seating sleeves. The implant analogs according to the invention are usable in all the usual dental implant systems. However, the implant analogs are also suitable for scanning implant reconstructions for virtual models.

### Bottom Removal

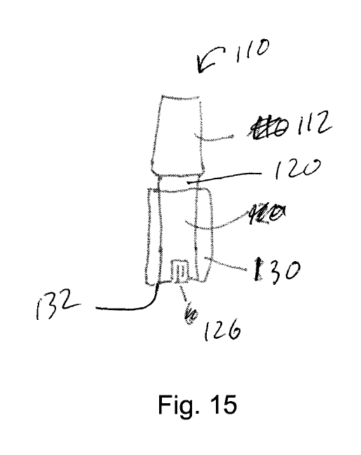

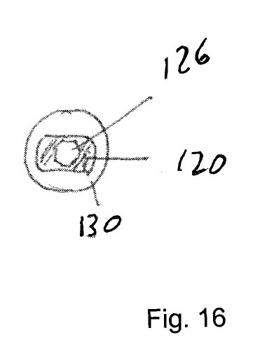

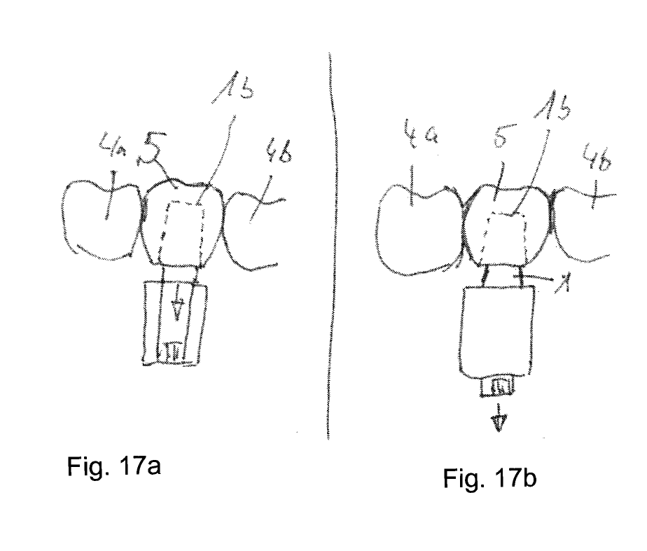

As seen in FIGS. 15 through 19, the implant analog system embodiment depicted includes an implant analog 110 having a head or conus 112 at a first end, which is towards the top in the figures. The implant analog 110 also has a shaft 120. At an end of the shaft 120 opposite the head 112 is an engagement element 126. The engagement element is constructed, arranged and adapted to receive a tool, such as a wrench, screw or other traction device, whereby traction or rotational force may be applied to the implant analog for adjusting it, moving it axially or removing it. The shaft portion of the implant analog is dimensioned to engage, as for example by sliding in the depicted embodiment, the inner wall of a sleeve 130. The shaft and inner wall of sleeve throughhole 132 are dimensioned such that the sleeve 130 may retain the implant analog 110. The implant analog 110 and sleeve 130 are further dimensioned such that the entire implant analog may be removed from either end of the throughhole 132 that proceeds axially through sleeve 130 and opens at either end of sleeve 130. The sleeve 130 may be made of plastic.

As seen in FIG. 19, the implant analog system of the depicted embodiment also includes a model 140. The model 140 also has throughholes 142 which proceed entirely through the model to a bottom side of the model 144, which side is opposite the side of the model engaging the prosthetic device 115. As the depicted embodiment, the system may also includes a base 150 for generally supporting the model 140. The base 150 may also have a throughhole 152 generally dimensioned and positioned to correspond to the throughhole 142 in the model 140 and correspond to the throughhole 132 and sleeve 130. Sleeve 130 may include a retention member 134 dimensioned and positioned to fixedly secure said sleeve 130 in said model 140.

Whereby, according to the depicted embodiment, a user may place implant analogs 110 in sleeves 130 such that they are held in model 140 for adjustment of the assembly of implant analogs relative to the prosthetic device 115. The implant analog 110 may be removed, and may be removed through sleeve throughhole 132, model throughholes 142 and, optionally, base throughholes 152, through the bottom of the entire assembly. Thus, an individual implant analog is removable without disassembling related implant analogs or the prosthetic device from the prosthesis side (top in the figures) of the model assembly. A tool may be used for removal.

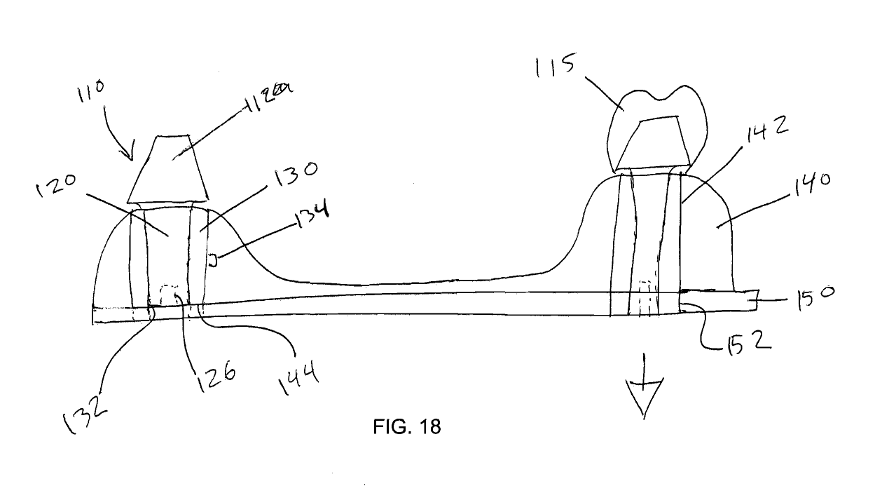

The implant analogs may be substantially cylindrical, but may also be conical, as depicted in FIG. 18.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An implant analog system comprising:
an implant analog having a shaft and a head, said head being adapted to support a prosthetic device;
an engagement member at an end of said shaft opposite said head, said engagement member being adapted to receive a tool such that traction may be placed on said implant analog;
a sleeve, said sleeve having a sleeve throughhole, said throughhole being dimensioned to receive said implant analog and to retain said implant analog in a user selected position;
said sleeve being constructed and arranged to be held in a model, said model having a first side contoured to engage a prosthetic device that is supported at least in part by said head of said implant analog, and said model having a second side opposite said first side;
said model having a model throughhole for receiving said sleeve, said model throughhole extending through said second side of said model;
whereby said implant analog may be removed through said sleeve throughhole and through said model throughhole in said second side of said model.

2. The implant analog system of claim 1 further comprising a base, said base being adapted to engage said second side of said model and said base having a base throughhole positioned such that said removal of said implant analog may be made through said base throughhole in said base.

3. An implant analog system comprising:
an implant analog having a shaft and a head, said head being adapted to support a prosthetic device;
an engagement member at an end of said shaft opposite said head, said engagement member being adapted to receive a tool such that traction may be placed on said implant analog;
a sleeve, said sleeve having a throughhole, said throughhole being dimensioned to receive said implant analog and to retain said implant analog in a user selected position;
whereby said implant analog may be removed through said sleeve throughhole and through said second side of said model in either direction.

4. The implant analog according to claim 1, further comprising;
a tenon-like projection on a bottom end surface of said implant analog head; and
an external thread dimensioned to connect with a screw element of said sleeve.

5. The implant analog according to claim 1, characterized in that said implant head is set obliquely to a longitudinal axis of said implant analog.

6. The implant analog according to claim 2, characterized in that an axis of the implant head is at an obtuse angle, to a line normal to said base (3).

7. The implant analog according to claim 1, characterized in that said sleeve is an inner sleeve to which an outer sleeve is assigned, where the inner sleeve and the outer sleeve are protected against rotation relative to each other through a slot located in a surface of the internal sleeve running along a long axis of the sleeve and a longitudinal bar provided on an inner wall of the outer sleeve and where said outer sleeve has an unbroken bar with an opening for a pin.

8. The implant analog according to claim 7, characterized in that the pin has profiling (31) at one end.

9. The implant analog according to claim 7, characterized in that said outer sleeve is provided with bars (21, 22) serving as protection against rotation.

10. The implant analog according to claim 1 characterized in that the implant analog is clamped into said sleeve by way of a screw element which can be inserted into sleeves.

11. The implant analog according to claim 1, characterized in that the implant analog is connected directly to said model with screw elements.

12. The implant analog according to claim 1, characterized in that said sleeve forms a seating sleeve and has a seating part (42, 50) and a sleeve part (43, 51).

13. The implant analog according to claim 12, characterized in that said sleeve part (43, 51) connects without a transition to said seating part (42, 50) and both sleeve parts have a common jacket surface.

14. The implant analog according to claim 1, characterized in that the implant analog is connected directly to said model with a conical backing piece (58).

15. The implant analog according to claim 1, characterized in that the implant analog is clamped in a shell (38) with a conical backing piece (58), which has a first cone (55) to hold the implant analog (2) and a cone (56) in the opposite direction from the first one to hold said backing piece (58).

16. The implant analog according to one of claim 1 characterized in that the sleeve (38, 49) has a cylindrical outer jacket with a constant outside diameter.

17. The implant analog according to one of claim 1, characterized in that said sleeve (38, 49) has a conical outer jacket with a seat part (50) that tapers in the direction of a sleeve part (51).

18. The implant analog of claim 1 wherein said implant analog is held in said sleeve with a bayonet mount.

19. The implant analog of claim 1 wherein said implant analog may be rotated to a first position for extraction through a top end of said sleeve.

20. The implant analog of claim 1 wherein said implant may be rotated to a second position for removal through a bottom of said sleeve.
